(19) United States
(12) Patent Application Publication
(10) Pub. No.: US 2023/0065706 A1
(43) Pub. Date: Mar. 2, 2023

(54) HYDROPONIC VERTICAL FARMING

(71) Applicants: Riam SHAMMAA, Toronto (CA); Mohamed ZAYED, Toronto (CA)

(72) Inventors: Riam SHAMMAA, Toronto (CA); Mohamed ZAYED, Toronto (CA)

(21) Appl. No.: 17/892,304

(22) Filed: Aug. 22, 2022

Related U.S. Application Data
(60) Provisional application No. 63/239,045, filed on Aug. 31, 2021.

(51) Int. Cl. A01G 31/06; A01G 9/24

(52) U.S. Cl. CPC A01G 31/06; A01G 9/249

(57) ABSTRACT

A cohesive and independent hydroponic system is provided having a water tank base supporting a hollow tower for housing plants for vertical farming. The hydroponic system has a central water control system position inside the water tank base and/or the hollow of the hollow tower for centralized control and easy of scalability.

### REFERENCE TO RELATED APPLICATIONS

This application claims the benefit of U.S. provisional application No. 63/239,045, filed on Aug. 31, 2021, the entire content of which is incorporated herein by reference.

### FIELD

The present disclosure generally relates to the field of hydroponic systems, namely hydroponic systems for use in vertical farming.

### BACKGROUND

Vertical farming is the practice of growing crops in vertically stacked layers in an controlled environment to optimize plant growth and typically uses soilless farming techniques. Current applications of vertical farming coupled with other state-of-the-art technologies, such as specialized LED lights, have resulted in greater crop yield than would receive through traditional farming methods.

The main advantage of utilizing vertical farming technologies is the increased crop yield that comes with a smaller unit area of land requirement. However, improvements to vertical farming structures are needed to maximize efficiency and yield.

### SUMMARY

In one aspect, there is provided a hydroponic system comprising: a water tank base for supporting a hollow tower for housing plants; and a central water control system position inside the water tank base and/or the hollow of the hollow tower, the central water control system comprising: a central column for transporting water from the water tank base up through the hollow tower to an upper end of the central column, wherein the central column is configured for fluid coupling at the upper end to an irrigation system for delivery of water from the water tank base to the plants.

In this respect, before explaining at least one embodiment in detail, it is to be understood that the embodiments are not limited in application to the details of construction and to the arrangements of the components set forth in the following description or illustrated in the drawings. Also, it is to be understood that the phraseology and terminology employed herein are for the purpose of description and should not be regarded as limiting.

Many further features and combinations thereof concerning embodiments described herein will appear to those skilled in the art following a reading of the instant disclosure.

### DESCRIPTION OF THE FIGURES

Embodiments of devices, apparatus, methods, and kits are described throughout reference to the drawings.

FIG. 1 shows a rectangular opening in a water tank base.

FIG. 2 shows a water tank base with drainage valve and a separate exist for electrical outlet.

FIG. 3 shows a float-based water intake system for managing water flow.

FIG. 4 shows a pump tubing for distribution of water and nutrients.

FIG. 5 shows an irrigation system with a closing valve.

FIG. 6 shows protruding stainless steel rods for holding and positioning lights around a vertical plant tower.

FIG. 7 shows vertically stacked pods occupying 1 square metre of floor space.

FIG. 8 shows the flow of water within a hollow tower for watering plants.

FIG. 9 shows a tubing extended from a pump to the valve.

FIG. 10 shows pods for holding plants.

### DETAILED DESCRIPTION

In accordance with the present disclosure, hydroponic system are provided for use in vertical farming. The hydroponic system described herein is an independent cohesive system that provides for closed plumbing, automation, and controlled lighting. The stand-alone design of the hydroponic system allows for easier management of vertical farming units, as well as easy of scalability.

In some embodiments, a hydroponic system comprises a water tank base 100 for holding a reservoir of water (optionally including fertilizer or nutritional supplements). The water tank base supports a hollow tower 200 for housing plants for vertical farming. In one embodiment, the hollow tower has a plurality of pods for holding a plant each. The hydroponic system has a central water control system contained within the water tank base and/or the inside space defined by the hollow tower. By keeping the central water control system inside, the hydroponic system allows for easy transport, management, and centralized control in one place.

In some embodiments the water base tank has an access opening 110 for an user to access the central water control system. In one embodiment, the access opening is located above the water line and sized to allow an user's hand to reach in and access controls inside the hydroponic system. The access opening may have a lid or a skirt to prevent backflow of water. In one embodiment, the water base tank has one or more additional openings for electrical outlet. In one embodiment, the water base tank has a drainage hole and an inlet for filling the water tank base with water.

In one embodiment, the water base tank has an float 120 inside for measuring water level in the water base tank. In one embodiment, the float activates switches to control drainage and/or filling of the water tank base with water.

In some embodiments, the central water control system comprises a central column 210 for transporting water from the water tank base up through the hollow tower to an upper end of the central column. The central column is configured for fluid coupling at the upper end to an irrigation system 300, thereby allowing delivery of water from the water tank base, up through the central column, and to the irrigation system which then distributes the water to the plants on the hollow tower. In one embodiment, the central column comprises tubing or pipes for transporting water. In one embodiment, the central column has a valve at the upper end for shunting water flow. In one embodiment, the central control system further comprises waterproof wiring connecting controls inside the water tank base to electrical devices or components located within or attached to the hollow tower. In some embodiments, the central column also comprises mist or fog generating ports 212 along its length, to maintain a desired moisture level within the hollow space defined by the hollow tower.

In some embodiments, the central water control system comprises a pump for pumping water from the water tank base up through the central column to the irrigation system. Controls to the pump may be accessed by an user through the access opening. Example controls for the pump include, but are not limited to: timers, pump speed control, water pumping schedule controls. In one embodiment, watering of the plants is managed or controlled by optimizing the pumping frequency and timing to provide a desired flow rate of water based on a particular plant's needs. In embodiments where the central column has a valve at the upper end, the valve allows for additional or emergency shunting of water to the irrigation system.

In some embodiments, the central water control system comprises one or more sensors. In one embodiment, the one or more sensors are for monitoring water in the water tank base, water in the central column, water distributed from the irrigation system, or elsewhere in the hydroponic system. In one embodiment, the central water control system comprises one or more sensors for monitoring air within or surrounding the hollow tower housing the plants. Example sensors include, but are not limited to temperature sensors, humidity sensors, water level sensors, light sensors, air composition or quality sensors, pH sensors, electrical conductivity sensors, or a combination thereof. In one embodiment, water quality sensors are located inside the water base tank that monitor water content and detect bacterial or algae growth or infections. In one embodiment, sensors are located outside of the water base tank for monitoring humidity, carbon dioxide or other gas levels in the air, air quality, air intake and air disposal.

In one embodiments, electrical or mechanical water level sensors are located in the water base tank that is wired to automatically control the pump's pumping rate, drainage rate, and/or filling of the water base tank with water.

In some embodiments, the hydroponic system comprises the irrigation system coupled to the central column and in fluid connection to the water tank base. In one embodiment, the irrigation system is positioned within the hollow space of the hollow tower and elevated to proximate to a top of the hollow tower, such that water distributed by the irrigation system showers down the interior hollow space of the hollow tower. In one embodiment, the irrigation system is elevated to at least 1 cm, preferably at least 2 cm above the topmost pod of the hollow tower.

In some embodiments, the irrigation system comprises a series of pipes with a plurality of openings for water to flow through. In one embodiment, the series of pipes are attached to the hollow tower. In other embodiments, the series of pipes are suspended from the top of the hollow tower. In yet other embodiments, the series of pipes are mounted on top of the central column and in fluid connection. In some embodiments, the series of pipes comprise a circumferential pipe section that deposits water onto an inside surface of the hollow tower. In one embodiment, the circumferential pipe section comprises a square loop of pipe, a circular loop of pipe, or a polygon loop of pipe. In one embodiment, the circumferential pipe section has a shape that corresponds to the interior circumference of the hollow tower for efficient distribution of water onto the interior surface of the hollow tower.

In some embodiments, the hydroponic system comprises a lighting system 400 mounted onto the hollow tower. In some embodiments, the lighting system comprises a plurality of lights positioned to surround the hollow tower. In one embodiment, the lighting system comprises outwardly radiating support arms mounted on top of the hollow tower for suspending the plurality of lights around the hollow tower. In one embodiment, the support arms are plurality of steel rods each mounted on top the hollow tower at one end and suspending one or more lights at the opposite end. In other embodiment, the support arms comprise a frame mounted on top of the hollow tower and a plurality of steel rods extending radially outward from the fame, with lights suspended from the steel rods. In some embodiments, the lights are detachable. Example lights include LED lights, incandescent light bulbs, or fluorescent light. Preferably, the lights are LED lights. In one embodiment, a plurality of LED lights are oriented vertically and positioned around the hollow tower, and preferably in regular intervals around the hollow tower.

In some embodiments, sufficient light source is provided such there is about 50-80% ration of lights to each circumferential row of pods on the hollow tower, preferably about 70%. In one embodiment, the hollow tower has 8 pods on each circumferential row and 6 vertical LED lights suspended around the hollow tower. In another embodiment, the hollow tower has 14 pods on each circumferential row and 10 vertical LED lights suspended around the hollow tower. In yet another embodiment, the hollow tower has 18 pods on each circumferential row and 12 vertical LED lights suspended around the hollow tower.

In some embodiments, the lighting system has electrical wiring that extends above the hydroponic system to an outlet. In some embodiments, the lighting system has electrical wiring extending down the central column, such that controls of the lighting system is accessible from the access opening.

In some embodiments, the hydroponic system comprises the hollow tower for holding plants. The hollow tower can be of various sizes or height, with pods 220 arranged around the hollow tower for housing plants for vertical farming. In one embodiment, the hollow tower is a single integral piece. In other embodiments, the hollow tower is comprises of multiple stacked pieces to allow for adjustable heights. In some embodiments, the hollow tower is sealed to the water tank base to direct the irrigated water back into the water tank base. In one embodiment, the hollow tower is rotatably sealed to the water tank base. In one embodiment, the hydroponic system has an adaptor lid to rotatably couple the hollow tower to the water tank base.

In some embodiments, the hollow tower has a plurality of pods extending through the wall of the hollow tower. In one embodiment, the pods are baskets for housing a plant. The roots of the plants to grow inward toward the center of the hollow tower, and the foliage of the plants to grow outward from the hollow tower. Hence, only the roots of the plants are watered by the irrigation system within the interior of the hollow tower, while an user can attend to the plant outside the hollow tower. In other embodiments, the hollow tower has a plurality of grooves for housing plants. In some embodiments, the hollow tower has pods that are arranged in circumferential rows. In one embodiment, each circumferential row is staggered with respect to the pods.

The interior surface of the hollow tower has a patterned shape or texture to direct water from the top of the hollow tower to the bottom in a manner that ensures all plants are sufficiently watered. Various shapes or textures are possible, for example: repeating shingles, grooves, duct systems, or combinations thereof. In some embodiments, the hollow tower has a smooth or plain surface.

Numerous details are set forth to provide an understanding of the examples described herein. The examples may be practiced without these details. The description is not to be considered as limited to the scope of the examples described herein.

### EXAMPLES

The following examples illustrate certain embodiments addressing specific design requirements and are not intended to limit the embodiments described elsewhere in this disclosure.

### Example 1—Hydroponic Tower

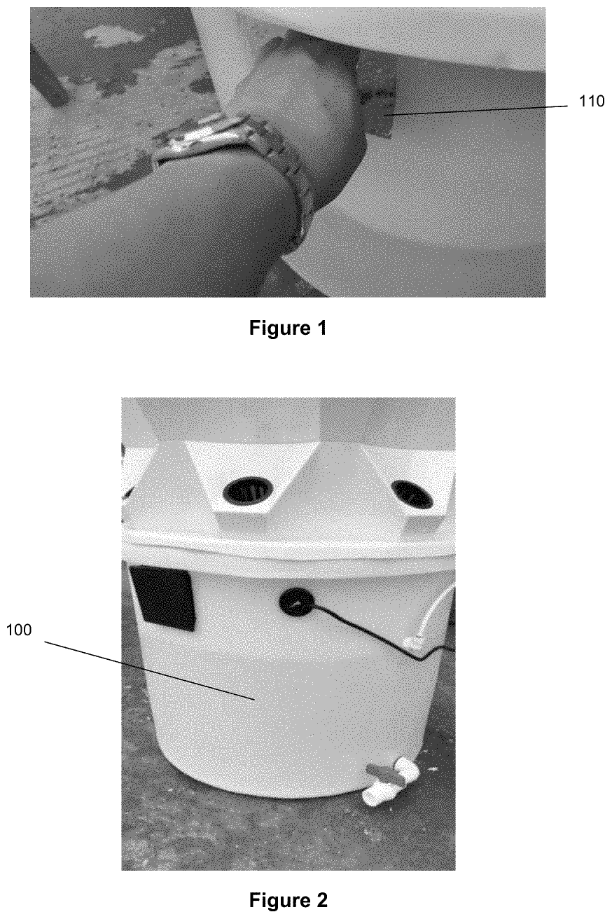

Tank and plumbing. A 100-litre see-through tank was used to facilitate water level and anomaly checking. The tank contains a pump with an irrigation system that stretches the length of the tower culminating in a square with holes directed at the pivot points and groves of the top most layer of the tower. The tank is equipped with a drainage system with easy access to the tank and corresponding pump through a rectangular opening towards the top of the tank and a drainage faucet at the bottom (see FIG. 1). The tank is also equipped with a separate exit for the electrical outlet for the pump electricity to guarantee safety and streamline the farming process (see FIG. 2).

The tank is covered by a lid that complements the grooves in the tower stem base to insure tower stability and efficient water return to the tank without leakage. This lid allows for the tower to be fully turned in the desired direction to allow easier manipulation in case of any space restrictions.

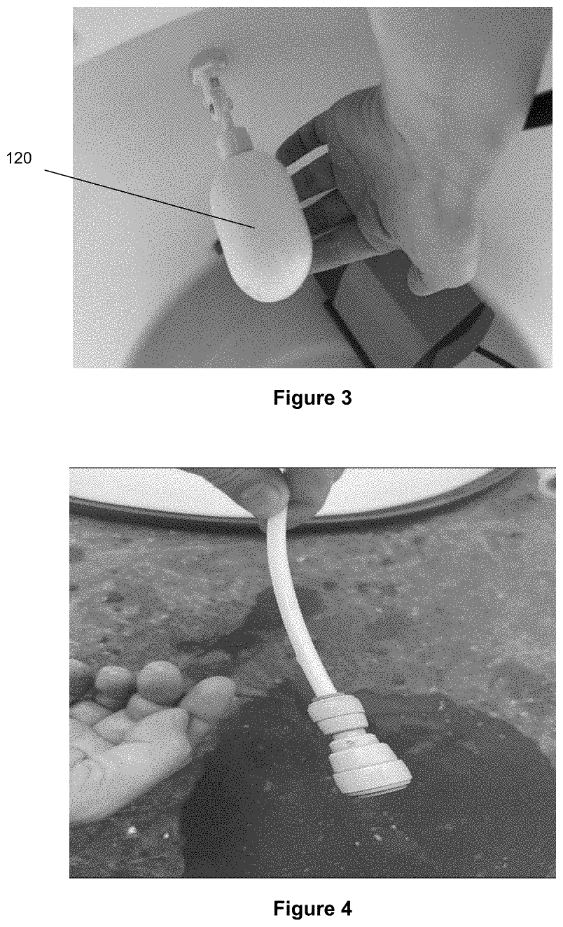

Water and nutrient control. The tank operates with a float based water intake system that stops the water from flowing in at the desired level and assures a safeguard against overflow in addition to equal water and nutrient intake by all tanks (see FIG. 3).

The tank is equipped with a high-quality submersible pump that propels water and nutrients upwards into the corresponding tubing to be disbursed by the square irrigation system at the top of the tower (see FIG. 4). All pumps are connected to an automatic central timer that is easily altered to insure all plants are growing and being fed in unison.

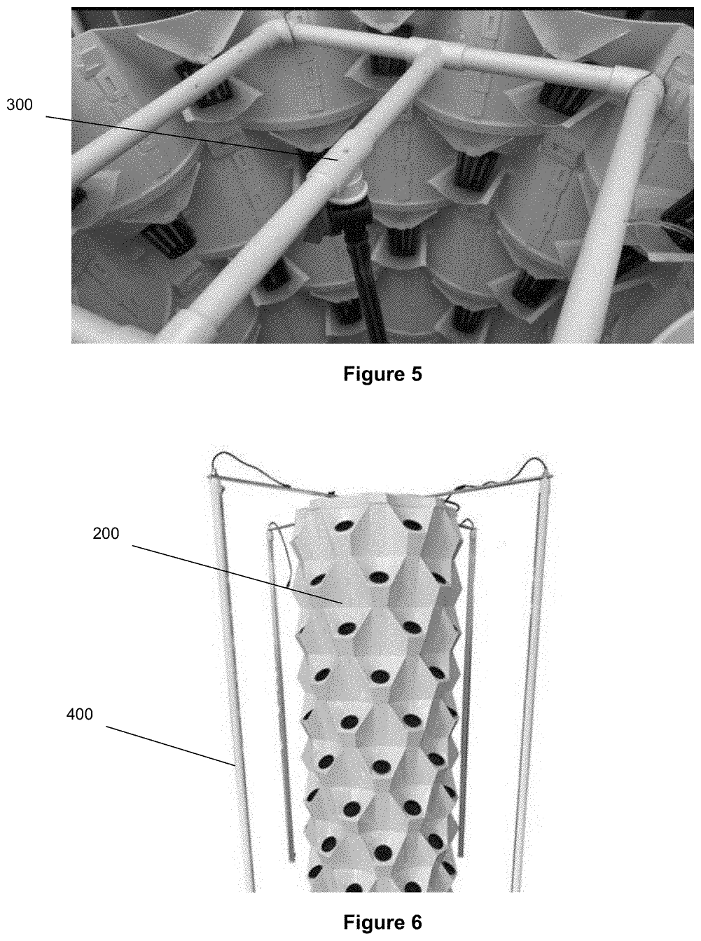

There is a red closing valve at the bottom of the square irrigation system (see FIG. 5) to create a redundancy in case of water or nutrient concerns and to allow for quick and efficient replacement of the square irrigation system in case of any defects.

All tanks in a single system are fed by a 1000-litre tank. The stored water is gravity propelled into the 100-litre tanks. The 1000-litre tank is fed by a Dosatron nutrient delivery system that absorbs the desired amount of nutrients and is powered by the water pressure coming in from a standard high performance garden hose.

Connecting tanks. The tanks are all connected by standard versatile tubing that is easily altered to the conditions of the housing facility. After connecting the main 1000-litre tank and the corresponding 100-litre tanks system, the standard versatile tubing ends in a drainage valve that insures plant, system, and client safety in case of emergency or contamination.

Lid and lights. The tower is covered by a lid made from the same materials. The lid is reinforced at the corners and acts as a protecting cover for the system from contamination as it aligns perfectly with the tower grooves with a reinforced lip covering them for extra protection. There are six protruding stainless steel rods that align perfectly with the stem of the tower with fittings at the terminal to hold the lights (see FIG. 6).

There are six LED lights that are 1.5 metres in length, IP65 waterproof and humidity grade, and CSA accredited with a clear screen at a corresponding degree to the surface, which are covered by the lights in the tower stem. The power is 30 W. The voltage is AC85-265V. The luminous flux is 3600 lm. The lights provide the full spectrum of lighting with the necessary Umol output for leafy green and flowering plant growth at the appropriate distance from the tower to extend plant growth outward and horizontally.

The lights hook with a washer and bolt at the terminal to insure safety and easy maneuverability to attach and detach during planting and harvesting. All six lights are connected at the middle point of the tower running along the protruding stainless steel rods to provide safety and support to the cables with a terminal combining all cables into one bundle connecting to the plug cable.

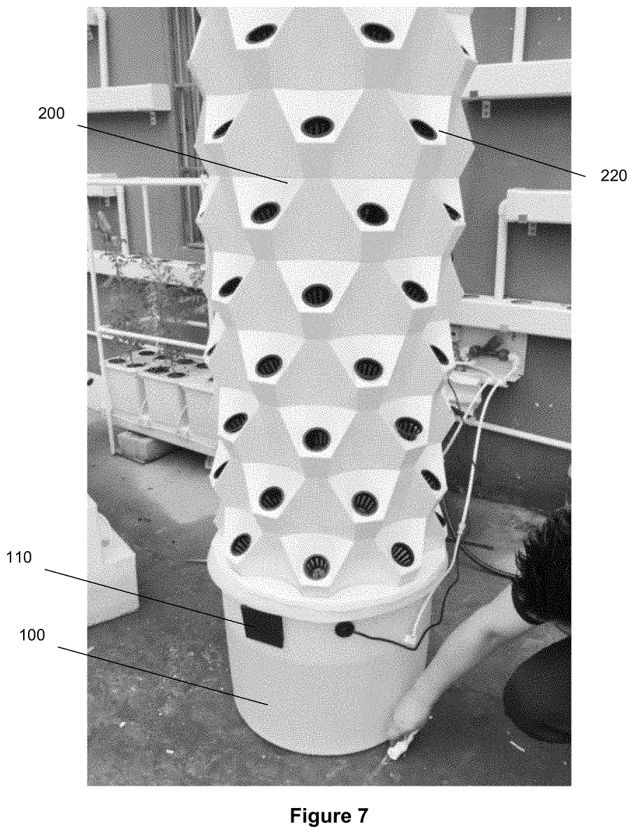

Stem and root housing. The tower is designed to ensure maximum utilization of surface area by allowing for the growth from seedling to maturity stage of leafy greens for 80 plants on less than 1 square metre of floor space (see FIG. 7).

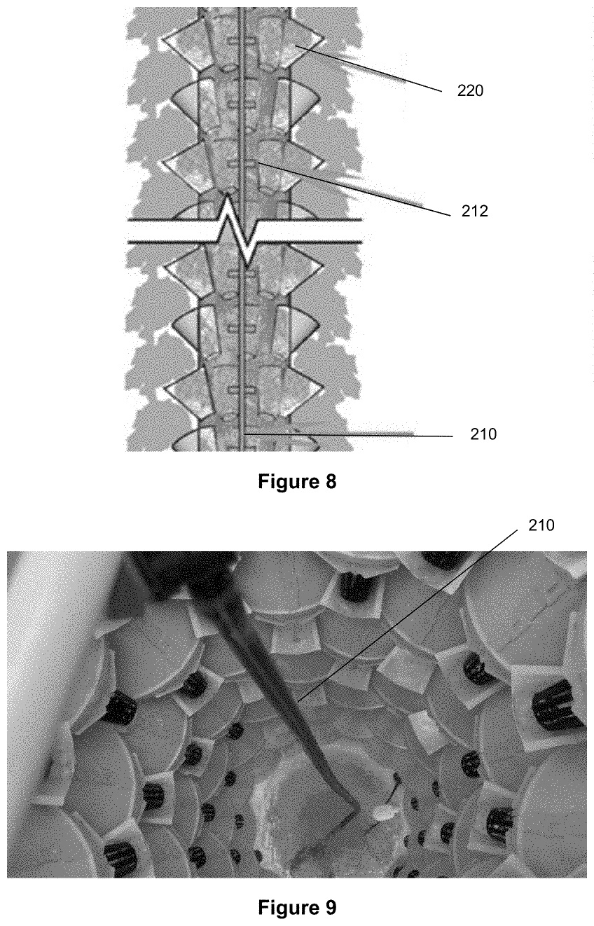

The tower stem is hexagonal is shape with protruding squares at the edges at every level. These squares and corresponding groves contain the pods containing the netted Rockwool housing. The stem is designed to perfectly disburse the nutrient solution being projected by the square irrigation system to all pods and root housing guaranteeing equal nutrient delivery to all 80 pods (see FIG. 8).

The tower stem rests atop the aforementioned tank lid in and is covered by the tower lid, which guarantees the safety of the nutrient solution and plants from contamination. The tubing extended from the pump to the red valve of the square irrigation system runs along the central point of the hexagon to insure it does not impede root growth, nutrient flow, and root housing (see FIG. 9).

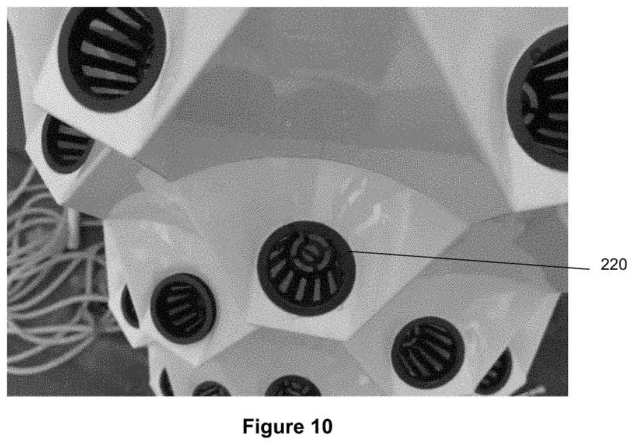

There are 80 pods (see FIG. 10) with 80 corresponding netted Rockwool housings that allow for root development through the horizontal spaces in the Rockwool netted housing while maintaining the integrity of the plant and associated Rockwool housing.

The Rockwool housing rests atop a plug in plastic basin that holds the protruding roots in place. The roots constantly feed on the nutrient solution being dispensed by the square irrigation system as it has a semicircular surface that holds the liquid solution preventing the roots from drying up interim irrigation cycles while allowing the renewal of the solution to prevent any water stagnation-born complications.

Although the embodiments have been described in detail, it should be understood that various changes, substitutions and alterations can be made herein. Moreover, the scope of the present application is not intended to be limited to the particular embodiments or examples described in the specification. As can be understood, the examples described above and illustrated are intended to be exemplary only.

For example, the present invention contemplates that any of the features shown in any of the embodiments described herein, may be incorporated with any of the features shown in any of the other embodiments described herein, and still fall within the scope of the present invention.

What is claimed is:

1. A hydroponic system comprising:
a water tank base for supporting a hollow tower for housing plants; and
a central water control system positioned inside the water tank base and/or the hollow of the hollow tower, the central water control system comprising:
a central column for transporting water from the water tank base up through the hollow tower to an upper end of the central column, wherein the central column is configured for fluid coupling at the upper end to an irrigation system for delivery of water from the water tank base to the plants.

2. The hydroponic system of claim 1, wherein the water tank base has a first opening for accessing the central water control system.

3. The hydroponic system of claim 1, wherein the central water control system comprises a pump for pumping water from the water tank base up through the central column to the irrigation system.

4. The hydroponic system of claim 1, wherein water tank base has a second opening for electrical outlet.

5. The hydroponic system of claim 1, wherein the central column comprises a tubing.

6. The hydroponic system of claim 1, wherein the central column has a valve at the upper end for shunting water flow.

7. The hydroponic system of claim 1, wherein the water tank base comprises a drainage hole and an inlet for filling the water tank base with water.

8. The hydroponic system of claim 1, wherein the central water control system comprises one or more sensors.

9. The hydroponic system of claim 8, wherein the one or more sensors are a temperature sensor, a light sensor, an air composition or quality sensor, a humidity sensor, a water level sensor, a pH sensor, an electrical conductivity sensor, or a combination thereof.

10. The hydroponic system of claim 1 comprising the irrigation system, and wherein the irrigation system comprises a series of pipes in fluid connection to the water tank base through the central column, the series of pipes having a plurality of openings to shower an interior surface of the hollow tower with water.

11. The hydroponic system of claim 1, comprising a lighting system mounted onto the hollow tower.

12. The hydroponic system of claim 11, wherein the lighting system comprises a plurality of lights positioned to surround the hollow tower.

13. The hydroponic system of claim 12, wherein the lighting system comprises outwardly radiating support arms mounted on top of the hollow tower for suspending the plurality of lights around the hollow tower.

14. The hydroponic system of claim 12, wherein the plurality of lights are LED lights positioned vertically around the hollow tower.

15. The hydroponic system of claim 14, wherein the lighting system comprises 6 support arms each suspending one LED light at regular intervals around the hollow tower.

16. The hydroponic system of claim 1 comprising the hollow tower, and wherein the hollow tower comprises a plurality of pods extending through a wall of the hollow tower for holding plants.

17. The hydroponic system of claim 16, wherein the plurality of pods are configured to allow the roots of the plants to grow inward toward the center of the hollow tower, and to allow the foliage of the plants to grow outward from the hollow tower.

18. The hydroponic system of claim 16, wherein the hollow tower has an irrigation pattern on an interior side for directing water to one or more of the plurality of pods.

19. The hydroponic system of claim 16, wherein the hollow tower is sealed to the water tank base to direct water into the water tank base.

20. The hydroponic system of claim 16, comprising an adaptor lid to rotatably couple the hollow tower to the water tank base.
